(19) United States
(12) Patent Application Publication
(10) Pub. No.: US 2017/0280750 A1
(43) Pub. Date: Oct. 5, 2017

(54) GAS SOURCE WITH AROMA COMPONENT FOR USE IN BEVERAGE MAKING

(71) Applicant: Bedford Systems LLC, Bedford, MA (US)

(72) Inventors: Jean-Paul Arnaud, Sandy Springs, GA (US); Matthew Elmer, Richmond, VT (US); Peter S. Given, JR., Stowe, VT (US); Jennifer Caitlin Carlson, Essex Junction, VT (US); Luther Hildebrand Leake, Waterbury Center, VT (US)

(73) Assignee: Bedford Systems LLC, Bedford, MA (US)

(21) Appl. No.: 15/477,931

(22) Filed: Apr. 3, 2017

Related U.S. Application Data
(60) Provisional application No. 62/316,716, filed on Apr. 1, 2016.

(51) Int. Cl. A23L 2/54; B65D 85/804; B65D 85/73; A23L 2/52; A23L 27/00

(52) U.S. Cl. CPC A23L 2/54; A23L 2/52; A23L 27/72; A23L 27/00; B65D 85/73; B65D 85/8043; A23V 2002/00

(57) ABSTRACT

Systems, methods and cartridges for carbonating or otherwise dissolving gas and an aroma component in a precursor liquid, such as water, to make a beverage. A gas source and aroma component can be provided in a cartridge which is used to generate gas that is dissolved into the precursor liquid. The gas source can be a charged zeolite material having adsorbed gas, and the aroma component can include encapsulated particles of aroma materials.

### RELATED APPLICATIONS

This application claims the benefit of priority under 35 U.S.C. §119 of U.S. Patent Application Ser. No. 62/316,716, which was filed on 1 Apr. 2016 and titled “Gas Source with Aroma Component for Use in Beverage Making,” the entire contents of which are hereby incorporated by reference in its entirety.

### BACKGROUND

The principles described herein relate to dissolving gas in liquids, e.g., carbonation, for use in preparing a beverage. Systems for carbonating liquids and/or mixing liquids with a beverage medium to make a beverage are described in a wide variety of publications, including U.S. Pat. Nos. 4,025,655; 4,040,342; 4,636,337; 6,712,342 and 5,182,084; and PCT Publication WO 2008/124851.

### SUMMARY

Aspects of the present system and method relate to carbonating or otherwise dissolving a gas in a precursor liquid, such as water, to form a beverage. In some embodiments, a carbon dioxide or other gas source can be provided in a cartridge which is used to generate carbon dioxide or another gas that is dissolved into the precursor liquid. In some embodiments, a beverage medium, such as a powdered drink mix or liquid syrup, may be provided in the same, or may be provided in a separate cartridge from the gas source and mixed with the precursor liquid (either before or after carbonation) to form a beverage. The use of one or more cartridges for the gas source and/or beverage medium may make for an easy to use and mess-free system for making carbonated or other sparkling beverages, e.g., in the consumer's home.

The term “carbonation” or “carbonated” is used herein to generically refer to beverages that have a dissolved gas, and thus refers to a sparkling beverage whether the dissolved gas is carbon dioxide, nitrogen, oxygen, air, or another gas or mixture of gases. Thus, the principles disclosed herein are not limited to forming beverages that have a dissolved carbon dioxide content, but rather may include any dissolved gas.

In one embodiment, a cartridge for use by a beverage forming machine in forming a beverage includes a container having a first chamber that is sealed and encloses a gas source material arranged to release a gas adsorbed in the gas source material, e.g., in response to the addition of a fluid introduced into the first chamber. The gas source material may be a solid molecular sieve, such as beads of a zeolite material that had adsorbed gas which is released in the presence of water or other fluid. An aroma component may also be included in the first chamber and be arranged to combine with gas released by the gas source material for delivery to a precursor liquid with the gas. For example, the aroma component may include a natural perfume, an essential oil, a fruit essence, other natural or synthetic flavoring materials, or combination of such compounds that, when mixed with a precursor liquid, may flavor the liquid. By “flavor,” it is meant that the aroma compound may provide materials that can be smelled and/or tasted by a user consuming a beverage. The cartridge container may have an inlet through which fluid is introducible by a beverage forming machine into the first chamber to cause the gas source material to release the gas, and an outlet through which gas released by the gas source and aroma component combined with the gas exits the first chamber for dissolution in a beverage. The aroma component may combine with the release gas by diffusing into, mixing with, and/or being entrained into flow of the released gas. Gas and aroma component that exits the cartridge may be mixed with a precursor liquid whereby the gas and aroma component are dissolved or otherwise mixed with a precursor liquid to form a beverage.

In some embodiments, the aroma component is encapsulated such that the aroma component is released for combination with the gas upon exposure of the encapsulated aroma component to a liquid. For example, the aroma component may be encapsulated in a polysaccharide, hydrocolloids, dextrins, proteins, and/or other food-grade, water-soluble polymers, or other water-soluble material, such as a gelatin, water-soluble gum, or starch. As a result, fluid used to cause the gas source to emit gas can also cause a release of an encapsulated aroma component.

In another embodiment, a method of making a beverage includes providing a cartridge having a sealed compartment that contains a gas source material including a solid molecular sieve having an adsorbed gas and an aroma component. Fluid may be introduced into the sealed compartment to cause the gas source material to release the adsorbed gas and to cause the aroma component to combine with the released gas. As noted above, the aroma component may be encapsulated and released upon exposure to the fluid introduced into the cartridge. In some cases, 20 ml to 40 ml of liquid water may be introduced into the cartridge to cause gas release. The combined gas and aroma component may be delivered to a precursor liquid to dissolve the combined gas and aroma component in the precursor liquid. For example, a precursor liquid, such as water, may be contained in a carbonation tank and the gas and aroma component may be combined with the water in the tank to dissolve in the water. The precursor liquid may then be dispensed with the dissolved gas and aroma component as a beverage, e.g., as a seltzer.

Introduction of the fluid into the cartridge may be done in different ways, e.g., water may be injected into the sealed compartment via an inlet of the cartridge. In some cases, the cartridge may be pierced to form the inlet, or the cartridge may have a defined inlet port or other arrangement. In some embodiments, the gas source material may include beads of a charged zeolite that are mixed with particles of encapsulated aroma material. In some cases, the beads of zeolite may be arranged so that at least 85% of the beads by weight have a size of 0.71 mm to 2.0 mm. By providing a large majority of the zeolite beads in this size range, a gas release rate can be suitably controlled whether an amount of activating fluid provided to the beads is controlled or not. Also, by controlling the gas release rate, the aroma component may be suitably combined with the gas in desired concentrations. In some embodiments, less than 5% of the beads have a size over 2.0 mm. This threshold has been found in certain applications to ensure that adsorbed gas is released at a suitably fast rate. That is, activating fluid, such as water, takes longer to penetrate into larger beads, and therefore gas release from internal portions of the bead farthest from the bead surface may take a relatively long time to be exposed to the water and release gas in response. By having less than 5% of the beads to have a size over 2.0 mm, gas release has been found to be acceptably fast. Moreover, less than 10% of the beads may have a size under 0.71 mm. In contrast to larger beads, smaller beads tend to release adsorbed gas more rapidly, e.g., because water penetrates into internal portions of the bead faster. Thus, beads under a certain size have been found to release adsorbed gas too quickly for some applications. By having less than 10% of the beads with a size under 0.71 mm, suitably slow gas release can be achieved, particularly in a cartridge-based application of a beverage machine.

Regarding the size of beads, a bead having a size less than 0.71 mm is one that passes through a U.S. Mesh 25 screen, whereas a bead having a size between 0.71 mm and 2.0 mm does not pass through a U.S. Mesh 25 screen but passes through a U.S. Mesh 10 screen. A bead having a size greater than 2.0 mm does not pass through a U.S. Mesh 10 screen. A “bead” as used herein refers to an object that may have a variety of different shapes, such as spherical, cylindrical, cuboid, capsule-shaped, and others. Also, in some embodiments, a bead has a ratio of a mass of adsorbed gas to a mass of the bead of at least 15%, and is arranged to release at least 95% of all adsorbed gas within 60 seconds when immersed in water. Thus, in these embodiments, a structure that does not have a ratio of adsorbed gas mass to bead mass of at least 15% and cannot release at least 95% of all adsorbed gas within 60 seconds of immersion in water is not a “bead.” For example, in some arrangements, a cartridge may include filler elements, such as uncharged zeolite masses that have a bead shape, in addition to charged zeolite beads, and the uncharged masses are not considered a “bead” since they have little or no adsorbed gas. Similarly, some zeolite particles in a cartridge may include a coating or otherwise are unable to release adsorbed gas within 60 seconds of water immersion, and thus are not considered “beads.”

In some embodiments, the cartridge includes a mass of gas source material of 10-50 grams and a volume of less than 50 ml. Such amounts are suitable to carbonate a beverage, e.g., the 10-50 grams of gas source material may have an amount of adsorbed gas equivalent to a volume of 300 ml to 2000 ml of the gas at atmospheric pressure. This amount of gas may be suitable to carbonate a volume of water of 200-1000 ml to a level of about 1-5 volumes. Also, an amount of aroma component in the cartridge may be 0.01 to 5 grams depending upon the aroma intensity, loading level, and release characteristics.

The container in which the gas source material and aroma component are contained may include a lid that is piercable by a beverage forming machine to form the inlet and outlet, e.g., an inlet for activating water or other fluid and an outlet for gas released from the gas source material and aroma component. In one embodiment, the top of the cartridge container may be piercable to form the inlet and outlet of the first chamber, a sidewall may extend downwardly from the top, and a rim may extend outwardly from a lower end of the sidewall. The rim may provide a clamping surface for a beverage machine to engage the cartridge to create a seal and help maintain gas released from the cartridge under suitable pressure in a closed chamber in which the cartridge is at least partially held. A filter may be included in the first chamber to resist exit of gas source material from the outlet of the first chamber. For example, in some cases, small particles of gas source material may tend to be carried by the flow of gas from the cartridge. The filter may help resist exit of the entrained particles, thereby helping to resist the particles from being carried to the precursor liquid to be carbonated.

In some embodiments, a cartridge container may also include a second chamber that is separated from the first chamber, with the second chamber being sealed and containing a beverage medium for mixing with a precursor liquid to form a beverage. For example, the beverage medium may be a syrup or other concentrate that is mixed with a beverage precursor in, or outside of, the cartridge. The second chamber may be located below the first chamber, and the first and second chambers may be separated by a wall. In one embodiment, the container may include a top, an upper sidewall that extends downwardly from the top, a bottom, a lower sidewall that extends upwardly from the bottom, and a rim that extends outwardly from a lower end of the upper sidewall and an upper end of the lower sidewall. The top may be piercable to form the inlet and outlet, the rim may be piercable (e.g., at an underside or lower surface of the rim) to form an inlet opening to the second chamber through which to receive pressurized gas into the second chamber, and the bottom may include an outlet opening through which beverage medium exits the second chamber, e.g., in response to pressurized gas forcing the beverage medium to exit.

### BRIEF DESCRIPTION OF THE DRAWINGS

The principles herein are described with reference to the following drawings in which like numerals reference like elements, and wherein:

FIG. 1 shows a perspective view of a cartridge in an illustrative embodiment;

FIG. 2 shows a cross sectional view of the FIG. 1 cartridge, according to one exemplary embodiment;

FIG. 3 shows a cross sectional view of a modified version of the FIG. 1 cartridge having only a gas source chamber, according to one exemplary embodiment;

FIG. 4 shows a side view of a beverage forming machine according to an illustrative embodiment;

FIG. 5 shows the cross sectional view of the FIG. 1 cartridge with piercing elements engaged at the lid of the cartridge, according to one exemplary embodiment; and

FIG. 6 shows a schematic diagram of components of a beverage forming system in an illustrative embodiment.

### DETAILED DESCRIPTION

It should be understood that aspects of the principles disclosed herein are described herein with reference to the figures, which show illustrative embodiments. The illustrative embodiments described herein are not necessarily intended to show all embodiments in accordance with the invention, but rather are used to describe a few illustrative embodiments. For example, the principles may be described with reference to a specific cartridge arrangement, but aspects of the invention are not limited to the cartridge arrangements described herein. Thus, these principles are not intended to be construed narrowly in view of the illustrative embodiments. In addition, it should be understood that aspects of the exemplary systems and methods may be used alone or in any suitable combination with other aspects of the invention.

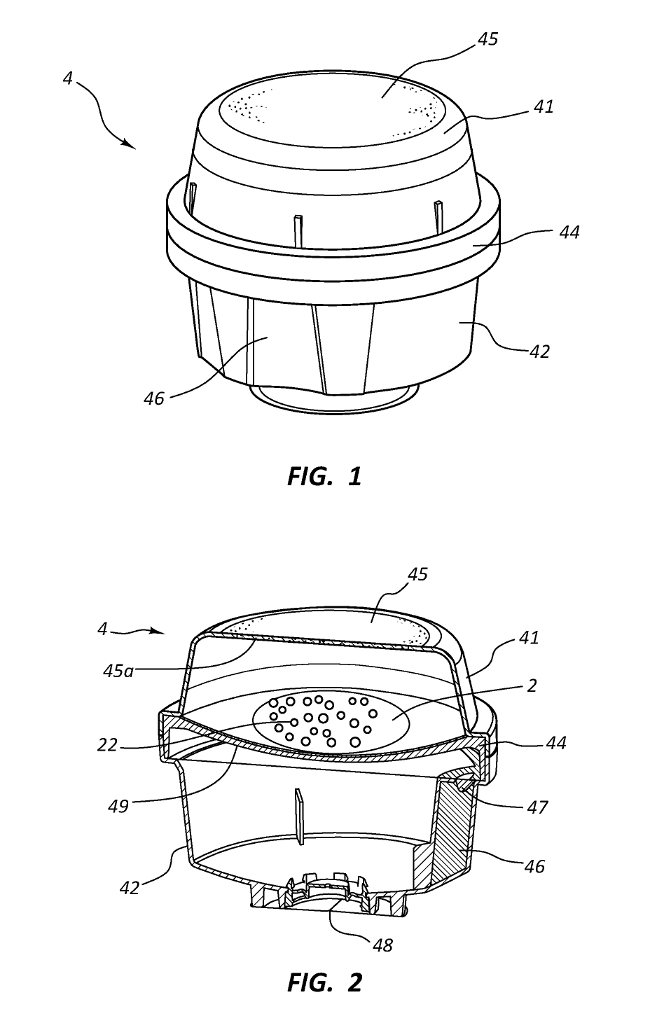

While alternative cartridge configurations are possible, FIGS. 1 and 2 show a cartridge 4 that may be used with a beverage making system that employs the cartridge to at least carbonate a beverage precursor liquid to form a beverage. In this embodiment, the cartridge 4 includes a container that defines an upper compartment or chamber 41, a lower compartment or chamber 42, and a rim or band 44 between a top and bottom of the cartridge 4. The top of the cartridge 4 includes a lid 45 that covers an opening of the container. The lid 45 is piercable to form one or more openings so as to access a gas source 2 (see FIG. 2) in the upper compartment 41. (Although in this embodiment, the lid 45 is a separate element, such as a sheet of foil/polymer laminate attached to the container body, the lid may be molded or otherwise formed integrally with the body.) Also, a filter 45a may be positioned below the lid 45, e.g., spaced apart from the lid 45 but parallel to the lid 45, although other arrangements are possible. This filter 45a may help prevent gas source material and/or other solid particles from exiting the upper compartment 41 during gas production. The upper compartment 41 is also defined in part by a wall 49 that is illustrated in FIG. 2 as having a concave up curve, but such a shape is not necessary, e.g., the wall 49 may be flat or concave down.

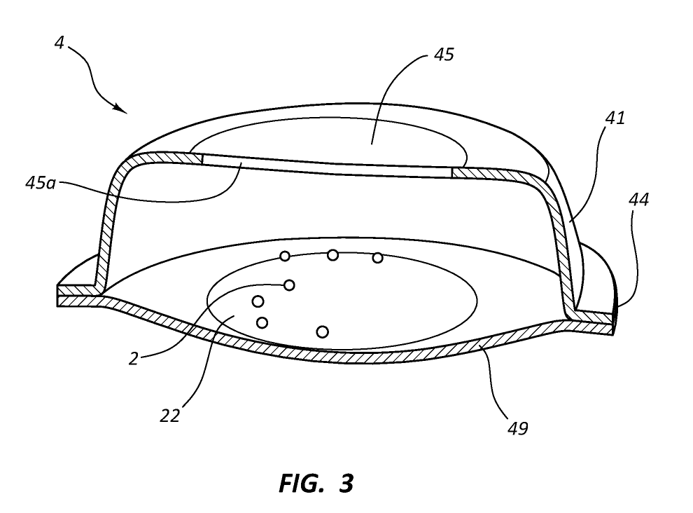

The lower compartment or chamber 42 can contain a beverage medium (not shown for clarity) that can be mixed with a precursor liquid to form a beverage. A piercable inlet 47 may be located at an underside of the rim 44 and adjacent an indexing groove 46 formed in the lower sidewall of the cartridge 4. As is discussed in more detail below, the inlet 47 may be pierced to allow access to the lower compartment 42, e.g., so pressurized gas or liquid can be introduced into the lower compartment 42 to move the beverage medium out of an outlet 48 of the lower compartment 42. In this embodiment, the outlet 48 includes a piercable membrane that can be pierced and opened to allow the beverage medium to exit, although other arrangements are possible, e.g., a self-closing septum valve or burstable seal may be provided at the outlet 48 that opens with increased pressure in the lower compartment 48. Cartridges are not limited to the arrangement shown in FIGS. 1 and 2, however, and other cartridge configurations, such as those that include only a gas source (e.g., only a rim 44 and upper compartment 41 like that shown in FIG. 3) to make a carbonated water, are possible. In the case of FIG. 3, the wall 49 forms a bottom of the cartridge container from which the rim 44 extends outwardly. The wall 49, as noted above, may be flat, or otherwise shaped and need not have the shape shown.

In accordance with an aspect of the exemplary system and method, the cartridge 4 contains a gas source material 2 in the form of a molecular sieve. That is, in this exemplary embodiment, the gas source material 2 is a charged adsorbent or molecular sieve, e.g., a zeolite material that has adsorbed an amount of carbon dioxide gas that is released in the presence of water or other activating fluid, whether in vapor or liquid form. Note, however, that aspects of the invention are not necessarily limited to use with carbon dioxide gas, but may be used with any suitable gas, such as nitrogen, which is dissolved in some beers or other beverages, oxygen, air, and others. Thus, reference to “carbonation”, “carbon dioxide source” “carbon dioxide activating fluid supply”, etc., should not be interpreted to limit any embodiments to use with carbon dioxide only. Instead, any suitable gas may be used.

In one exemplary embodiment, the charged adsorbent is a zeolite such as analcime, chabazite, clinoptilolite, heulandite, natrolite, phillipsite, or stilbite along with a suitable binder or filler component, e.g., to help form the zeolite into a desired shape. The zeolite may be naturally occurring or synthetic, and may be capable of holding up to about 20% carbon dioxide by weight or more. The zeolite material may be arranged in any suitable form, such as a solid block (e.g., in disc form), particles of spherical, cubic, irregular or other suitable shape, and others. In one example, the molecular sieve is arranged in the form of beads that have a size of 0.71 mm to 2.0 mm. One particularly effective arrangement includes beads of solid molecular sieve material in a cartridge such that at least 85% of the beads by weight have a size of 0.71 mm to 2.0 mm. In some embodiments, less than 5% of the beads have a size over 2.0 mm, which has been found in certain applications to ensure that adsorbed gas is released at a suitably fast rate. That is, activating fluid, such as water, takes longer to penetrate into larger beads, and smaller bead sizes tend to release gas more quickly when exposed to moisture. Thus, having a suitably small size of the beads may tend to cause quicker release of adsorbed gas. Moreover, less than 10% of the beads may have a size under 0.71 mm. In contrast to larger beads, smaller beads tend to release adsorbed gas more rapidly, so beads under a certain size have been found to release adsorbed gas too quickly for some applications. By having less than 10% of the beads with a size under 0.71 mm, suitably slow gas release can be achieved, particularly in a cartridge-based application for use with a beverage machine. In this particular embodiment, a 50 gram or less mass of molecular sieve beads has been found to release 95% of adsorbed gas or more within 20-40 seconds after being exposed to 20-40 ml of liquid water. This release rate is suitably slow to help prevent high pressure spikes while being suitable fast to allow for the carbonation and dispensing of a beverage in less than 5 minutes.

Regarding the size of beads, a bead having a size less than 0.71 mm is one that passes through a U.S. Mesh 25 screen, whereas a bead having a size between 0.71 mm and 2.0 mm does not pass through a U.S. Mesh 25 screen but passes through a U.S. Mesh 10 screen. A bead having a size greater than 2.0 mm does not pass through a U.S. Mesh 10 screen.

In accordance with another aspect of the invention, the cartridge compartment or chamber that contains the gas source material 2 also contains an aroma component 22 arranged to combine with gas released by the gas source material for delivery to a precursor liquid with the gas. Thus, gas released by the gas source material 2 may be delivered along with the aroma component 22 for dissolution or other mixing with a precursor liquid, e.g., to carbonate the liquid and provide the liquid with an aroma and/or taste associated with the aroma component. (Since human taste is influenced by smell, an aroma component that provides a smell but is not detectable by the human tongue may still be said to provide the beverage with a flavor. Similarly, an aroma component may provide a material that can be detected by human taste receptors, but provides little or no smell.)

In some embodiments, the aroma component 22 may be encapsulated so as to protect the aroma component 22 from oxidation or other degradation, and may be released for combination with gas released by the gas source material 2. For example, an aroma component may be encapsulated in a water-soluble material that breaks down or otherwise releases the aroma component upon exposure of the water-soluble material to a liquid. In some embodiments, water may be provided to the cartridge chamber to cause the gas source to emit gas, and this water may also cause aroma components to be released from the encapsulant. The encapsulated aroma component may be arranged in particles of any suitable size, and the particles may be mixed with the gas source material. In some embodiments, the aroma component 22 may be in the form of a dry powder having particle sizes between 1 micron and 1 millimeter. A flavor load for each particle may be about 10% to 70%, e.g., an amount of material that contributes to the beverage flavor may be about 10% to 70% of all materials included in an encapsulated aroma component 22, such as encapsulating shell material, aroma carrier material, etc. In some embodiments, the aroma component 22 particles may be arranged to fall apart or otherwise release aroma materials relatively rapidly upon wetting and, according to one embodiment, without sticking or clumping upon wetting. The aroma component 22 may be mixed with zeolite or other gas source materials 2.

Accordingly, in some embodiments, the cartridge container may be arranged to have an inlet through which fluid (such as liquid water or water vapor) is introducible by a beverage forming machine into the cartridge to cause the gas source material 2 to release the gas, and is arranged to have an outlet through which gas released by the gas source 2 and aroma component 22 combined with the gas exits the cartridge for dissolution in a beverage. The fluid may cause both gas release and release of the aroma component, and the gas and aroma component may combine, e.g., by molecules or other small particles of aroma component being swept out of the cartridge by the flow of gas from the cartridge. In some cases, the inlet and/or outlet may be formed by piercing a portion of the cartridge, such as the lid 45 in the embodiments described above.

In some embodiments, the aroma component 22 includes aroma materials and/or carrier materials such as a natural perfume, an essential oil, a fruit essence, triglyceride oils, citrus oils, ethyl alcohol, propylene glycol, triacetin, benzyl alcohol or any suitable combination of such materials or other materials. Such materials may be harvested or otherwise collected in any suitable way, such as by condensing volatile oils or other materials from a vapor. In some cases, a beverage may normally or naturally include an aroma component, such as hop oils or other similar materials in beer or an essence in a fruit juice. These aroma components may be collected from the beverage, such as by distillation, condensation, etc., and then combined with a gas source in a cartridge for later use in flavoring a beverage while dissolving gas from the gas source in the beverage. Alternately, or in addition, synthetic aroma components made via laboratory or other techniques may be used in a cartridge as an aroma component. Such chemicals are well known and not described in detail herein.

If an aroma component is encapsulated, any suitable material and/or encapsulation technique may be used. For example, an aroma component may be encapsulated in a polysaccharide, a gelatin, a water-soluble gum, a starch, or combinations thereof to form particles of encapsulated aroma component. The particles may be arranged so that exposure of the particles to water or other liquid causes release of the encapsulated aroma component. Release of the aroma component may allow volatile oils or other similar materials to vaporize and mix with gas released from a gas source material. It should be understood that any suitable encapsulating technique may be used, such as techniques that form a core/shell structure and/or liposome structure where an aroma component payload is surrounded by an encapsulating material. Though examples are not necessarily limited to such an arrangement, a shell material may include a wide variety of substances, such as waxes, fats, shellac, protein (whey, zein, gelatin, soy, etc.), or a hydrocolloid, e.g., starch or modified starch, cellulosics, xanthan, gellan, pectin, and the like, or combinations thereof. Core/shell structures may be made by any suitable process, such as solvent evaporation, spinning disk, electro-hydrodynamic spraying, spray drying, fluidized bed coating, and the like, or combinations thereof. In another arrangement, a core payload may be surrounded by nano clay platelets (e.g., particles a few nanometers in width and hundreds of nanometers in length). As is known, such platelets can impede oxygen migration, and therefore act as a barrier to oxidation of the aroma component and/or other materials in the core. Liposome structures may be made, for example, with lecithin or components of lecithin (phospholipids and lyso-phosopholipids) which surround an encapsulated aroma component as a result of having interfacial tension lowering properties and the addition of external energy (homogenization, ultrasonic treatment, or other energy input mechanisms). Liposomes can be uni-lamellar or multi-lamellar, depending on formula and processing parameters. For beverage applications, liposomes favorably encapsulate oil-soluble components like flavonoids.

Other encapsulation techniques involve the use of nano-porous or other porous structures that can encapsulate oil and/or water-soluble substances by capillary action, interfacial attraction and/or other mechanisms. Materials suitable for this type of encapsulation include cellulose particles, silica particles, and/or natural clay (Kaolin). Cyclodextrins may also be considered nano-porous materials, in that they encapsulate substances that “fit” a cavity of the ringed structure, depending upon both the hydrodynamic size of the encapsulated substance, and the size of the ring (e.g., based on the type of cyclodextrin used). Release of the encapsulant may be by diffusion, physical shear, pH change, enzymatic action or other mechanisms. Yet other encapsulation techniques include inclusion particles and/or crystalline structures. Inclusion particles may be millimeter-sized particles formed of a gelling polymer, or a natural substance like comminuted fruit pieces. Particles prepared by gelling a polymer can also include oil-soluble encapsulation substances in their matrix during polymerization, e.g., gelling of sodium alginate upon addition of calcium. By this means, oil-soluble materials may be entrapped in an aqueous gel until the gel is broken by physical, environmental, or metabolic means. Regarding crystalline structures, sub-micron structures having a continuous structured phase and a network of nanopores can be fabricated from edible materials like phospholipids and monoglycerides, when processed at the correct ratio of surfactant, encapsulant, and oil/water phase. These materials may absorb and release encapsulated substances much like nano-porous structures described above.

In one example, a method of making a beverage, includes providing a cartridge having a sealed compartment that contains a gas source material which includes a solid molecular sieve having an adsorbed gas and an aroma component. As noted above, the aroma component may be encapsulated in a water-soluble or other material so that the aroma component is released when contacted by water or other fluid. Alternately, the aroma component need not be encapsulated and may simply be contained in the same space with the gas source material. In yet other embodiments, the aroma component may be contained in a compartment of the cartridge which is separate from the compartment where the gas source material is located. The aroma compartment may be opened when the cartridge is pierced by a beverage machine, in response to the gas source material releasing gas (e.g., as a pressure rises in the cartridge), or other mechanism. Alternately, the aroma compartment may be separated from the gas source compartment by a permeable element, such as a filter. In one example, gas emitted by the gas source may pass through the filter to the aroma component where aroma component is entrained or otherwise combined with the gas for exit from the cartridge.

Fluid may be introduced into the sealed compartment to cause the gas source material to release the adsorbed gas and to cause the aroma component to combine with the released gas. For example, water may be introduced into the compartment to cause the gas source material to emit gas. In some cases, a beverage machine may pierce the cartridge and inject water or other fluid into the cartridge via the pierced inlet opening. The water may also cause the aroma component to be released, e.g., if the aroma component is encapsulated in a water-soluble material. The aroma component and the gas may combine, e.g., by the aroma component being entrained in a flow of the gas and/or the aroma component diffusing into the gas.

The combined gas and aroma component may be delivered to a precursor liquid to dissolve the combined gas and aroma component in the precursor liquid. For example, the gas and aroma component may be delivered in pressurized form to a carbonation tank where the gas and aroma component are dissolved in a precursor liquid in the tank, such as water. The carbonation tank may be pressurized and/or chilled to increase a rate of dissolution of the gas and aroma component in the liquid. In other embodiments, the gas and aroma component may be dissolved in the precursor liquid in other ways, such as via an in-line carbonator, or other mechanism.

Then, the precursor liquid may be dispensed with dissolved gas and aroma component as a beverage. For example, an amount of precursor liquid with dissolved gas and aroma component may be dispensed from a carbonation tank to a user's cup as a finished beverage. In other cases, the precursor liquid and dissolved gas and aroma component may be mixed with another material, such as a beverage medium, to form a beverage. Other treatments of the beverage may be used as well, such as whipping, frothing, mixing with other beverages, and so on.

A cartridge container employed in some examples may be made of any suitable materials, and is not necessarily limited to the constructions shown herein. For example, the cartridge may be made of, or otherwise include, materials that provide a barrier to moisture and/or gases, such as oxygen, water vapor, etc. In one embodiment, the cartridge may be made of a molded polymer or polymer laminate, e.g., formed from a sheet including a layer of polystyrene, polypropylene and/or a layer of EVOH and/or other barrier material, such as a metallic foil. Moreover, the cartridge materials and/or construction may vary according to the materials contained in the cartridge. For example, a portion of the cartridge 4 containing a gas source material may include a robust moisture barrier, whereas a beverage medium portion may not include such a high moisture resistance. Thus, the cartridges may be made of different materials and/or in different ways. In addition, the cartridge interior may be differently constructed according to a desired function. For example, where beverage medium is mixed with precursor liquid in the cartridge, a beverage medium cartridge portion may include baffles or other structures that cause the liquid/beverage medium to follow a tortuous path so as to encourage mixing. The gas source cartridge portion may be arranged to hold the gas source in a particular location or other arrangement in the interior space, e.g., to help control wetting of the gas source with activating liquid. Thus, as used herein, a “cartridge” may take any suitable form, such as a pod (e.g., opposed layers of filter paper encapsulating a material), capsule, sachet, package, or any other arrangement. The cartridge may have a defined shape, or may have no defined shape (as is the case with some sachets or other packages made entirely of flexible material). The cartridge may be impervious to air and/or liquid, or may allow water and/or air to pass into the cartridge.

A cartridge may also be arranged to provide a visual or other detectable indication regarding the cartridge's fitness for use in forming a beverage. For example, the cartridge may include a pop-up indicator, color indicator, or other feature to show that the gas source has been at least partially activated. Upon viewing this indication, a user may determine that the cartridge is not fit for use in a beverage making machine. In another embodiment, an RFID tag may be associated with a sensor that detects gas source activation (e.g., via pressure increase), beverage medium spoilage (e.g., via temperature increase), or other characteristic of the cartridge, which may be transmitted to a reader of a beverage making machine. The machine may display the condition to a user and/or prevent activation of the machine to use the cartridge to form a beverage.

In one example, the cartridge or cartridges used to form a beverage using the beverage making system may have a volume that is less, and in some cases substantially less, than a beverage to be made using the cartridge(s). For example, a cartridge may have upper and lower compartments 41, 42 that each have a volume that is about 50 ml or less, and yet can be used to form a beverage having a volume of about 200-500 ml or more. In some embodiments, an amount of charged adsorbent (e.g., a charged zeolite) of about 10-50 grams (which has a volume of less than 50 ml) and 0.01 to 5 grams of an aroma component can be used to produce about 300-1000 ml of carbonated water having a carbonation level of up to about 4-5 volumes. Moreover, it is well known that beverage-making syrups or powders having a volume of less than about 50 ml, or less than about 100 ml, can be used to make a suitably flavored beverage having a volume of about 300-500 ml. Thus, relatively small volume cartridges (or a single cartridge in some arrangements) having a volume of about 100 ml to about 250 ml or less may be used to form a carbonated beverage having a volume of about 100 to 1000 ml, and a carbonation level of at least about 1 to 4 volumes in less than 120 seconds, e.g., about 60 seconds, and using pressures under 80 psi.

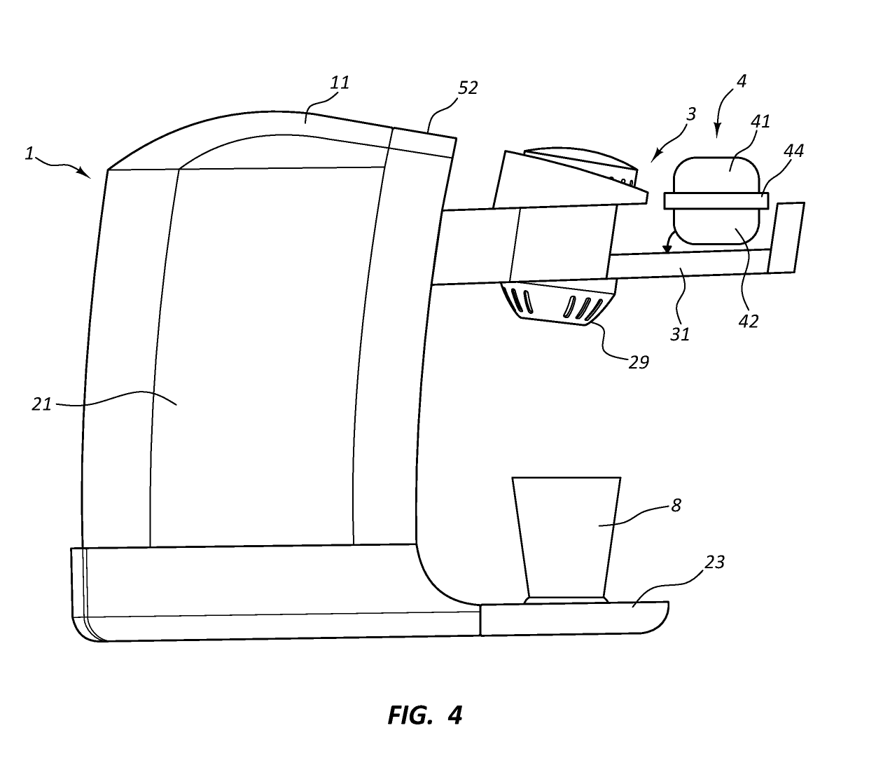

FIG. 4 shows an illustrative embodiment of a beverage making machine 1 that can employ a cartridge in accordance with one or more examples. In this embodiment, components of the beverage making machine 1 are located in or on a housing 21 which includes a drip tray 23 to support a user's cup or other container 8 and a reservoir 11 to provide water (a precursor liquid) to make a beverage. In this case, the reservoir 11 is optionally removable from the housing 21 and contains beverage precursor liquid that is used to form a beverage dispensed at a dispensing station 29 into the user's container 8. The reservoir 11 includes a removable lid that can be removed to provide precursor liquid into the reservoir 11, but such a lid may not be required. Moreover, the reservoir 11 need not be removable and/or may be replaced by a plumbed connection to a main water source in some cases. The beverage precursor liquid can be any suitable liquid, including water (e.g., flavored or otherwise treated water, such as sweetened, filtered, deionized, softened, carbonated, etc.), or any other suitable liquid used to form a beverage, such as milk, juice, coffee, tea, etc. (whether heated or cooled relative to room temperature or not). The reservoir 11 is part of a beverage precursor supply which provides the precursor liquid for conditioning of some kind, e.g., carbonation, filtering, chilling, mixing with a beverage medium, etc., and subsequent dispensing as a beverage.

A cartridge 4 containing a gas source, aroma component and/or a beverage medium may be associated with a cartridge holder 3 of the machine 1. The gas source may emit carbon dioxide or other gas which is used by the machine 1 to carbonate the precursor liquid, and an aroma component may be combined with the gas for dissolution with the precursor liquid. A beverage medium, such as a flavoring agent, may be mixed with precursor liquid as well. In this embodiment, the cartridge 4 may be associated with the cartridge holder 3 by pulling a sliding drawer 31 forwardly to expose a cartridge receiver or receiving area of the drawer 31. The cartridge holder 3 may be accessed by an opening of the sliding drawer, which may be opened and/or closed by a user pulling the sliding drawer, or by an automated opening and/or closing; which automated opening and/or closing may be facilitated by belts, gears, actuators, and the like. The cartridge 4, which in this case includes an upper compartment or chamber 41 containing a gas source 2 and a lower compartment or chamber 42 containing a beverage medium, may be placed in the cartridge receiving area of the drawer 31 and the drawer 31 closed by sliding to the left in FIG. 4. Thereafter, a user may interact with an interface 52, such as a touch screen, button or other device by which the user can cause the machine 1 to make a beverage. In response, the cartridge 4 may be clamped at a rim or band 44 located between the upper and lower compartments 41, 42 by the cartridge holder 3 and the compartments 41, 42 accessed to form the beverage. As is discussed in more detail below, the principles described herein may relate to a cartridge holder's ability to hold the upper and lower compartments 41, 42 of the cartridge 4 in spaces having different pressures (e.g., the upper compartment 41 may be held in a more highly pressurized space to receive carbonating gas than the lower compartment 42) and/or the holder's ability to pierce an inlet of the lower compartment 42 at an underside of the rim or band 44 to access the beverage medium (e.g., by injecting pressurized air or other gas into the lower compartment 42, thereby forcing the beverage medium to exit the cartridge and be dispensed at the dispensing station 29). Since the cartridge 4 may be replaceable, a user may exchange the cartridge 4 to make different beverages, such as carbonated water only, a carbonated and flavored beverage, a still and flavored beverage, etc.

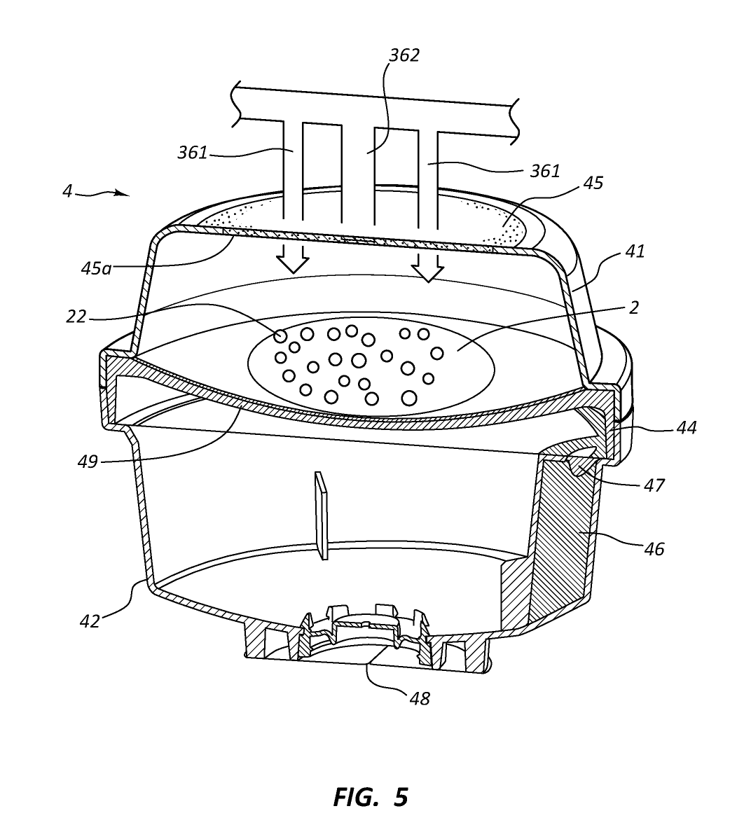

FIG. 5 shows an illustrative embodiment for accessing the upper compartment 41 of the cartridge 4 when the cartridge 4 is held in the cartridge holder 3 of the beverage making machine 1. In this arrangement, one or more piercing elements 361 may pierce the lid 45 to introduce activating fluid into the upper compartment 41, and a piercing element 362 may pierce the lid 45 to allow gas emitted by the gas source and aroma component to exit the cartridge 4. Though not necessary, the piercing elements 361 are arranged to penetrate through the lid 45 and the filter 45a so that activating fluid can be introduced below the filter 45a. However, the piercing element 362 is arranged to pierce only the lid 45, but not the filter 45a. In this way, gas emitted in the upper compartment 41 by the gas source material 2 must pass through the filter 45a before exiting to the carbonating gas supply. This may help prevent gas source material, such as zeolite particles, from exiting the cartridge 4 and passing to the precursor liquid or portions of the machine 1. In some embodiments, an aroma component may be positioned on or above the filter 45a so as to combine with gas as it exits the cartridge. For example, the filter may be coated with an aroma component, whether encapsulated or not, which may combine with gas as it exits the cartridge. In another example, the aroma component may be provided in a sealed bag or other container at or near the filter 45a so that the container is pierced by the piercing elements to release the aroma component. A variety of arrangements are possible for the filter 45a, such as a piece of filter paper mentioned above, a hydrophobic non-woven material that permits gas to pass, but resists liquid passage, or other element that permits gas to exit the cartridge 4, but resists movement of gas source material and/or liquid. In addition or alternately to the filter 45a, a conduit that receives the carbonating gas may include a filter element, such as a filter plug in the conduit, to help further resist movement of gas source materials from the cartridge 4. The piercing elements, may include a hollow needle, spike, blade, knife or other arrangement, to form a suitable opening in the cartridge 4. In this embodiment, the piercing elements 361 include tubular elements with an activating fluid discharge opening at a distal end such that activating fluid can be released from the piercing elements 361 below the filter 45a. In contrast, the piercing element 362 is relatively dull so as to penetrate the lid 45, but not the filter 45a. Alternately, the cartridge 4 may have defined openings, e.g., one or more ports, that include a septum or other valve-type element that permits flow into and/or out of the cartridge 4.

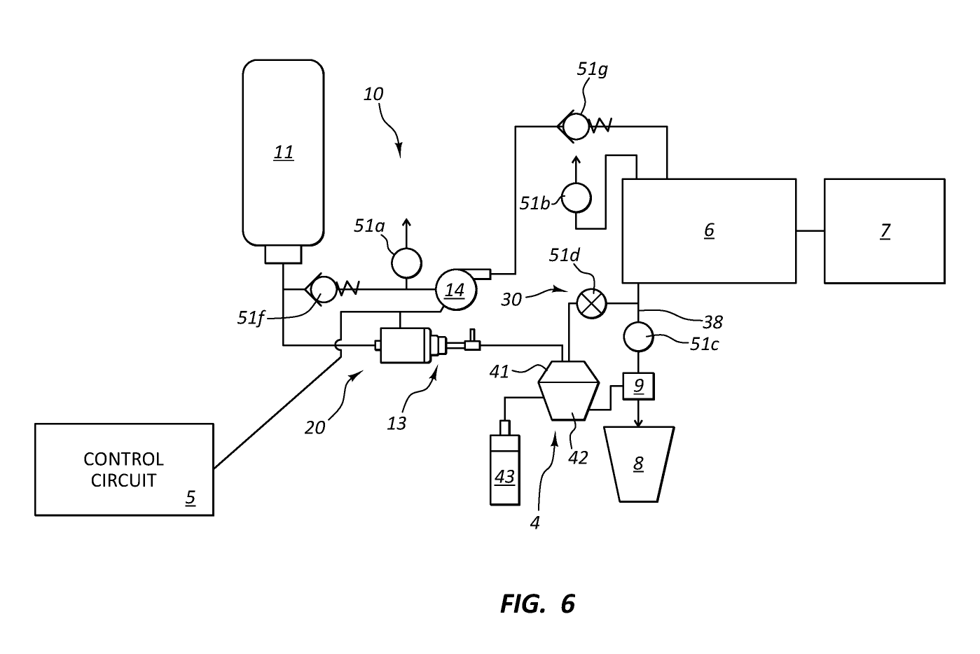

While a beverage making machine 1 may employ different liquid and gas flow path arrangements, FIG. 6 shows one such arrangement that may be used in the beverage making machine 1. In this embodiment, precursor liquid provided by a precursor liquid supply 10 originates in the reservoir 11, which may be removable from the machine 1, e.g., to allow for easier filling, or may be fixed in place. Although in this embodiment a user initially provides the beverage precursor liquid in the reservoir 11, the precursor supply 10 may include other components to provide liquid to the reservoir 11, or to be used in place of the reservoir 11, such as a plumbed water line, controllable valve, and liquid level sensor to automatically fill the reservoir 11 to a desired level, a second water reservoir or other tank that is fluidly connected to the reservoir 11, and other arrangements. Liquid is delivered by a pump 14 to the carbonation tank 6 via a check valve 51f upstream of the pump 14 and a check valve 51g downstream of the pump 14. The check valves 51f, 51g may help prevent backflow from the carbonation tank 6, e.g., when the tank 6 is relatively highly pressurized during the carbonating process. In this instance, the pump 14 is a diaphragm pump, but other pump types are possible. The carbonation tank 6 may be suitably filled with liquid using any suitable control method, such as by sensing a level in the tank 6 using a conductive probe, pressure sensor, optical sensor or other sensor. A tank vent valve 51b may be opened during filling to allow the pressure in the tank 6 to vent, or may remain closed during filling, e.g., to allow a pressure build up in the tank 6. An activating fluid supply 20 which includes a pump 13 is arranged to provide activating fluid to the upper compartment of the cartridge 4, i.e., to cause the gas source material 2 to release gas to the carbonation tank 6. Gas and aroma component emitted by the cartridge 4 is routed to the tank 6 via a valve 51d. A control circuit 5 may control operation of the valves 51, e.g., the valves 51 may include electromechanical or other actuators, as well as include sensors to detect various characteristics, such as temperature in the tank 6, pressure in the tank 6, a flow rate of gas or liquid in any of the system flow lines, etc.

To form a beverage, a user may associate a cartridge 4 with the machine 1, e.g., by loading the cartridge 4 into a cartridge holder 3 in a way like that discussed with respect to FIG. 4. Of course, a cartridge may be associated with the machine 1 in other ways, such as by screwing a portion of the cartridge into engagement with the machine 1, etc. With the cartridge 4 associated with the machine 1, the control circuit 5 may then activate the machine 1 to deliver liquid to the cartridge 4, e.g., to cause carbon dioxide to be generated and aroma component to be released. (Though this embodiment uses a cartridge with a gas source activated by a fluid, other arrangements are possible.) The control circuit 5 may start operation of the machine 1 in an automated way, e.g., based on detecting the presence of a cartridge 4 in the holder 3, detecting liquid in the carbonation tank 6 and closure of the holder 3, and/or other characteristics of the machine 1. Alternately, the control circuit 5 may start system operation in response to a user interacting with an interface 52, e.g., pressing a start button or otherwise providing input (e.g., by voice activation) to start beverage preparation.

To initiate carbonation after the tank is provided with a suitable amount of precursor liquid, the vent valve 51b may be closed and the pump 13 controlled to pump liquid into the upper compartment 41 of a cartridge 4 that contains a gas source 2. That is, the machine 1 may include a carbon dioxide activating fluid supply 20 that provides a fluid, e.g., in a controlled volume, at a controlled rate or otherwise to control a gas production rate, to a cartridge 4 so as to activate a carbon dioxide source in the upper compartment 41 to release carbon dioxide gas. In this embodiment, the carbon dioxide source includes a charged adsorbent or molecular sieve, e.g., a zeolite material that has adsorbed some amount of carbon dioxide gas that is released in the presence of water, whether in vapor or liquid form. Other arrangements or additions are possible for the carbon dioxide activating fluid supply 20, such as a dedicated liquid supply for the cartridge 4 that is separate from the precursor liquid supply, a pressure-reducing element in the conduit, a flow-restrictor in the conduit, a flow meter to indicate an amount and/or flow rate of fluid into the cartridge 4, a syringe, piston pump or other positive displacement device that can meter desired amounts of liquid (whether water, citric acid or other material) to the cartridge 4, and others. In another embodiment, the activating fluid supply 20 may include a gravity fed liquid supply that has a controllable delivery rate, e.g., like the drip-type liquid supply systems used with intravenous lines for providing liquids to hospital patients, or may spray atomized water or other liquid to provide a water vapor or other gas phase activating fluid to the cartridge 4.

A carbon dioxide gas supply 30 may be arranged to provide carbon dioxide gas and aroma component from the cartridge 4 to an area where the gas is used to carbonate the liquid, in this case, the carbonation tank 6. The gas supply 30 may be arranged in any suitable way, and in this illustrative embodiment includes a conduit that is fluidly connected between the cartridge 4 and a carbonated liquid outlet of the carbonation tank 6. A gas control valve 51d is controllable by the control circuit 5 to open and close the flow path through the gas supply conduit. (Note that in some embodiments, the valve 51d may be a check valve that is not controllable by the control circuit 5.) In some examples, the carbonation gas and aroma component are delivered via a carbonating gas supply line that is fluidly coupled to the dispense line of the carbonation tank so as to deliver carbon dioxide gas to the outlet of the carbonation tank to carbonate the precursor liquid. This arrangement may provide advantages, such as introducing the carbonating gas and aroma component at a relatively low point in the tank, which may help increase contact of the gas with the precursor liquid, thereby enhancing dissolution of the gas. In addition, the flow of carbonating gas through at least a portion of the dispense line 38 may help purge the dispense line 38 of liquid, helping to re-carbonate the liquid, if desired. The gas conduit may be connected to the dispense line 38 close to the dispense valve 51c so as to purge as much liquid from the dispense line 38 as possible.

The gas supply 30 may include other components than a conduit and valve, such as pressure regulators, safety valves, additional control valves, a compressor or pump (e.g., to increase a pressure of the gas), an accumulator (e.g., to help maintain a relatively constant gas pressure and/or store gas), and so on. The use of an accumulator or similar gas storage device may obviate the need to control the rate of gas output by a cartridge. Instead, the gas source may be permitted to emit gas in an uncontrolled manner, with the emitted gas being stored in an accumulator for later delivery and use in producing a sparkling beverage. Gas released from the accumulator may be released in a controlled manner, e.g., at a controlled pressure and/or flow rate. Also, carbonation and flavoring of the precursor liquid with the aroma component may occur via one or more mechanisms or processes, and thus is not limited to one particular process. For example, while delivery of carbon dioxide gas to the outlet of the carbonation tank 6 may function to help dissolve carbon dioxide in the liquid, other system components may further aid in the carbonation process. In some embodiments, a sparger may be used to introduce gas and aroma component into the carbonation tank, precursor liquid may be circulated in the tank, and/or other techniques may be used to alter a rate at which carbonating gas is dissolved.

Before, during and/or after carbonation of the liquid in the carbonation tank 6, a cooling system 7 may chill the liquid. The cooling system 7 may operate in any suitable way, e.g., may include ice, refrigeration coils or other cooling elements in thermal contact with the carbonation tank 6. In addition, the carbonation tank 6 may include a mixer or other agitator to move the liquid in the tank 6 to enhance gas dissolution and/or cooling. Operation in forming a beverage may continue for a preset amount of time, or based on other conditions, such as a detected level of carbonation, a drop in gas production by the cartridge 4, or other parameters. During operation, the amount of liquid provided to the cartridge 4 may be controlled to control gas output by the cartridge 4. Control of the liquid provided to the cartridge 4 may be made based on a timing sequence (e.g., the pump may be operated for a period of time, followed by stoppage for a period, and so on), based on detected pressure (e.g., liquid supply may be stopped when the pressure in the tank 6 exceeds a threshold, and resume when the pressure falls below the threshold or another value), based on a volume of activating liquid delivered to the holder 3 (e.g., a specific volume of liquid may be delivered to the cartridge 4 in one or more discrete volumes), or other arrangements.

With the precursor liquid in the carbonation tank 6 ready for dispensing, the vent valve 51b may be opened to reduce the pressure in the carbonation tank 6 to an ambient pressure. As is known in the art, depressurizing the carbonation tank prior to dispensing may aid in maintaining a desired carbonation level of the liquid during dispensing. With the tank 6 vented, the vent valve 51b may be closed and a pump vent valve 51a may be opened. The pump 14 may then be operated to draw air or other gas into the inlet side of the pump 14 and pump the gas into the carbonation tank 6 so as to force the precursor liquid in the tank 6 to flow into the dispense line 38. That is, according to one exemplary embodiment, the arrangement of FIG. 6 may incorporate a single pump that may be used to both deliver precursor liquid to a carbonation tank or other carbonation location as well as deliver pressurized gas (air) to the carbonation tank to dispense carbonated liquid from the tank. Alternatively, separate dedicated pumps may be used for each operation. The exemplary single pump feature, optionally combined with the feature of using the same pump to deliver activating fluid to a gas source, may make for a simplified system with fewer components. While the pump 14 delivers air to the carbonation tank, the dispense valve 51c is opened and the gas valve 51d is closed during liquid dispensing. The dispensed liquid may enter a mixing chamber 9 at which the carbonated liquid and beverage medium provided from the lower compartment 42 of the cartridge 4 are combined. The beverage medium may be moved out of the cartridge 4 and to the mixing chamber 9 by introducing pressurized gas into the lower compartment 42, e.g., by way of an air pump 43. Other arrangements are possible, however, such as routing gas from the upper compartment 41 under pressure to the lower compartment 42.

The beverage medium may include any suitable beverage making materials (beverage medium), such as concentrated syrups, ground coffee or liquid coffee extract, tea leaves, dry herbal tea, powdered beverage concentrate, dried fruit extract or powder, natural and/or artificial flavors or colors, acids, aromas, viscosity modifiers, clouding agents, antioxidants, powdered or liquid concentrated bouillon or other soup, powdered or liquid medicinal materials such as powdered vitamins, minerals, bioactive ingredients, drugs or other pharmaceuticals, nutriceuticals, etc., powdered or liquid milk or other creamers, sweeteners, thickeners, and so on. As used herein, “mixing” of a liquid with a beverage medium includes a variety of mechanisms, such as the dissolving of substances in the beverage medium in the liquid, the extraction of substances from the beverage medium, and/or the liquid otherwise receiving some material from the beverage medium.

The control circuit 5 may use one or more sensors to control a carbonation level of the precursor liquid, a temperature to which the liquid is chilled (if at all), a time at which and during which beverage medium is delivered to the mixing chamber 9, a rate at which carbonating gas is produced and delivered to the tank 6, and/or other aspects of the beverage making process. For example, a temperature sensor may detect the temperature of the precursor liquid in the carbonation tank 6. This information may be used to control system operation, e.g., warmer precursor liquid temperatures may cause the control circuit 5 to increase an amount of time allowed for carbon dioxide gas to be dissolved in the precursor liquid. In other arrangements, the temperature of the precursor liquid may be used to determine whether the machine 1 will be operated to carbonate the liquid or not. For example, in some arrangements, the user may be required to add suitably cold liquid (and/or ice) to the reservoir 11 before the machine 1 will operate. (As discussed above, relatively warm precursor liquid temperatures may cause the liquid to be insufficiently carbonated in some conditions.) In another embodiment, a pressure sensor may be used to detect a pressure in the carbonation tank 6. This information may be used to determine whether the carbonation tank 6 is properly or improperly filled, if a pressure leak is present, if carbonation is complete and/or to determine whether sufficient carbon dioxide gas is being produced by the cartridge 4. For example, low detected pressure may indicate that more carbon dioxide needs to be generated, and thus cause the control circuit 5 to allow more liquid to be delivered by the activating fluid supply 20 to the cartridge 4. Likewise, high pressures may cause the flow of liquid from the activating fluid supply 20 to be slowed or stopped. Thus, the control circuit 5 can control the gas pressure in the carbonation tank 6 and/or other areas of the machine 1 by controlling an amount of liquid delivered to the cartridge 4. Alternately, low pressure may indicate that there is a leak in the system and cause the system to indicate an error is present. In some embodiments, measured pressure may indicate that carbonation is complete. For example, pressure in the tank 6 may initially be detected to be at a high level, e.g., around 70-80 psi, and later be detected to be at a low level, e.g., around 40 psi due to gas being dissolved in the liquid. The low pressure detection may indicate that carbonation is complete. A sensor may also detect the presence of a cartridge 4 in the cartridge holder 3, e.g., via RFID tag, optical recognition, physical sensing, etc. If no cartridge 4 is detected, or if the control circuit 5 detects that the cartridge 4 is spent, the control circuit 5 may prompt the user to insert a new or different cartridge 4. For example, in some embodiments, a single cartridge 4 may be used to carbonate multiple volumes of precursor liquid. The control circuit 5 may keep track of the number of times that the cartridge 4 has been used, and once a limit has been reached (e.g., 10 drinks), prompt the user to replace the cartridge. Other parameters may be detected by a sensor, such as a carbonation level of the precursor liquid (which may be used to control the carbonation process), the presence of a suitable vessel to receive a beverage discharged from the machine 1 (e.g., to prevent beverage from being spilled), the presence of water or other precursor liquid in the carbonation tank 6 or elsewhere in the precursor supply 10, a flow rate of liquid in the pump 13 or associated conduit, the presence of a headspace in the carbonation tank 6 (e.g., if no headspace is desired, a valve may be activated to discharge the headspace gas, or if only carbon dioxide is desired to be in the headspace, a snifting valve may be activated to discharge air in the headspace and replace the air with carbon dioxide), and so on.

The control circuit 5 may also be arranged to allow a user to define a level of carbonation (i.e., amount of dissolved gas in the beverage, whether carbon dioxide or other). For example, the control circuit 5 may include a touch screen display or other user interface 52 that allows the user to define a desired carbonation level, such as by allowing the user to select a carbonation volume level of 1, 2, 3, 4 or 5, or selecting one of a low, medium or high carbonation level. Cartridges used by the machine 1 may include sufficient gas source material to make the highest level of carbonation selectable, but the control circuit 5 may control the system to dissolve an amount of gas in the beverage that is consistent with the selected level. For example, while all cartridges may be arranged for use in creating a “high” carbonation beverage, the control circuit 5 may operate the machine 1 to use less of the available gas (or cause the gas source to emit less gas than possible) in carbonating the beverage. Carbonation levels may be controlled based on a detected carbonation level by a sensor, a detected pressure in the carbonation tank 6 or elsewhere, an amount of gas output by the cartridge 4, or other features.

In another embodiment, the cartridge 4 may include indicia readably by the controller, e.g., an RFID tag, barcode, alphanumeric string, etc., that indicates a carbonation level to be used for the beverage. After determining the carbonation level from the cartridge 4, the control circuit 5 may control the machine 1 accordingly. Thus, a user need not select the carbonation level by interacting with the machine 1, but rather a carbonation level may be automatically adjusted based on the beverage selected. In yet another embodiment, a user may select a gas source cartridge 4 that matches a carbonation level the user desires. Different carbonation levels may be provided in the different cartridges by having different amounts of gas source in the cartridge 4. For example, cartridges providing low, medium and high carbonation levels may be provided for selection by a user, and the user may pick the cartridge that matches the desired carbonation level, and provide the selected cartridge to the machine 1. Thus, a gas source cartridge labeled “low” may be chosen and used with the system to create a low level carbonated beverage.

A user may alternately be permitted to define characteristics of a beverage to be made by interacting in some way with a cartridge 4 to be used by the machine 1. For example, a tab, notch or other physical feature of the cartridge may be altered or formed by the user to signify a desired beverage characteristic. For example, a broken tab, slider indicator, a covered or uncovered perforation on a portion of the cartridge, etc., that is created by the user may indicate a desired carbonation level, an amount of beverage medium to use in forming the beverage (where the machine 1 is controllable to use less than all of the beverage medium in the cartridge to form a beverage), and so on. Features in the cartridge 4 may also be used by the control circuit 5 to detect features of the cartridge, a beverage being formed or other components of the machine 1. For example, light guides in a cartridge 4 may provide a light path to allow the controller 5 to optically detect a level of beverage medium in the cartridge 4, a flow of precursor liquid in the cartridge 4, pressure in the cartridge (e.g., where deflection of a cartridge portion can be detected and indicates a pressure), a position of a piston, valve or other cartridge component, an absence of beverage medium in the cartridge (to signify completion of beverage formation), and so on. Other sensor features may be incorporated into the cartridge, such as electrical sensor contacts (e.g., to provide conductivity measurements representative of a carbonation level or other properties of a precursor liquid), an acoustic sensor (to detect gas emission, fluid flow, or other characteristics of the cartridge), and so on.

As noted above, by arranging the gas source and/or providing activating fluid to the gas source in a controlled way, the rate at which adsorbed gas is released may be suitably controlled. This feature can make the use of some gas sources, such as a charged zeolite material, possible without requiring gas storage or high pressure components. For example, zeolites charged with carbon dioxide tend to release carbon dioxide very rapidly and in relatively large quantities (e.g., a 30-gram mass of charged zeolite can easily produce 1-2 liters of carbon dioxide gas at atmospheric pressure in a few seconds in the presence of less than 20-40 ml of water). This rapid release can in some circumstances make the use of zeolites impractical for producing relatively highly carbonated liquids, such as a carbonated water that is carbonated to a level of 2 volumes or more. That is, dissolution of carbon dioxide or other gases in liquids typically takes a certain amount of time, and the rate of dissolution can only be increased a limited amount under less than extreme conditions, such as pressures within about 150 psi of ambient and temperatures within about +/−40 to 50 degrees C. of room temperature. By controlling the rate of carbon dioxide (or other gas) production for a carbon dioxide (or other gas) source, the total time over which the carbon dioxide (or other gas) source emits carbon dioxide (or other gas) can be extended, allowing time for the carbon dioxide (gas) to be dissolved without requiring relatively high pressures. In some examples, the liquids may have at least up to about 3.5 volume carbonation levels in less than 60 seconds, at pressures under about 40 psi, and at temperatures around 0 degrees Celsius. This capability may allow for a carbonated beverage machine to operate at relatively modest temperatures and pressures, potentially eliminating the need for relatively expensive high pressure tanks, conduits and other components, as well as extensive pressure releases, containment structures and other safety features that might otherwise be desired, particularly for a machine to be used in the consumer's home. Of course, as discussed above and elsewhere herein, some examples are not limited to use with carbon dioxide, and instead any suitable gas may be dissolved in a liquid in accordance with all aspects of this disclosure.

The cartridges 4 used in various embodiments may be arranged in any suitable way, such as a relatively simple frustoconical cup-shaped container having a lid attached to the top of the container, e.g., like that in some beverage cartridges sold by Keurig, Incorporated of Reading, Mass. and shown in U.S. Pat. No. 5,840,189, for example. In one embodiment, a cartridge having a frustoconical cup-shaped container and lid may have an approximate diameter of about 30-50 mm, a height of about 30-50 mm, an internal volume of about 30-60 ml, and a burst resistance of about 80 psi (i.e., a resistance to cartridge bursting in the presence of a pressure gradient of about 80 psi from the inside to outside of the cartridge in the absence of any physical support for the cartridge). However, as used herein, a “cartridge” may take any suitable form, such as a pod (e.g., opposed layers of filter paper encapsulating a material), capsule, sachet, package, or any other arrangement. The cartridge may have a defined shape, or may have no defined shape (as is the case with some sachets or other packages made entirely of flexible material. The cartridge may be impervious to air and/or liquid, or may allow water and/or air to pass into the cartridge. The cartridge may include a filter or other arrangement, e.g., in the beverage medium cartridge 4b to help prevent some portions of the beverage medium from being provided with the formed beverage, and/or in the gas cartridge 4a to help prevent carbon dioxide source material from being introduced into the beverage or other system components.

Having thus described several examples, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. A cartridge for use by a beverage making machine to make a beverage, comprising:
a container including a first sealed chamber;
a fluid activated gas source material disposed in the first chamber, the gas source material being a solid molecular sieve; and
an aroma component associated with the first chamber;
wherein the container includes an inlet portion configured to receive a fluid into the first chamber, and an outlet portion configured to release a combination of a gas and the aroma component.

2. The cartridge of claim 1, wherein the aroma component is configured to be released when exposed to the fluid.

3. The cartridge of claim 2, wherein the aroma component is encapsulated in a polysaccharide.

4. The cartridge of claim 1, wherein the aroma component is encapsulated in a water-soluble material.

5. The cartridge of claim 4, wherein the aroma component is encapsulated in at least one of a gelatin, a food-grade water-soluble polymer, a water-soluble gum, a starch, a polysaccharide, a hydrocolloid, a dextrin, or a protein.

6. The cartridge of claim 4, wherein exposure of the water-soluble material to the fluid causes a release of the encapsulated aroma component.

7. The cartridge of claim 1, wherein the aroma component includes at least one of a natural perfume, an essential oil, a fruit essence, a natural flavoring material, or a synthetic flavoring material.

8. The cartridge of claim 1, further comprising a second sealed chamber including an outlet portion;
wherein the second sealed chamber includes a beverage medium configured to be mixed with a precursor liquid to form a beverage.

9. The cartridge of claim 1, wherein the gas source material comprises a zeolite material formed in beads in which at least 85% of the beads by weight have a size of 0.71 mm to 2.0 mm.

10. The cartridge of claim 9, wherein:
the beads each have a ratio of a mass of adsorbed gas to a mass of the beads of at least 15%; and
wherein the beads each release at least 95% of all adsorbed gas within 60 seconds when immersed in the fluid.

11. The cartridge of claim 1, wherein the gas source material has a mass of 10-50 grams and a volume of less than 50 ml.

12. The cartridge of claim 1, wherein the gas source material has an amount of adsorbed gas equivalent to a volume of 300 ml to 2000 ml of the gas at atmospheric pressure.

13. The cartridge of claim 1, wherein the gas source material is configured to release the adsorbed gas upon an introduction of 20 ml to 40 ml of liquid water to the first chamber.

14. The cartridge of claim 1, further comprising a filter in the first chamber configured to resist exit of the gas source material from the outlet portion.

15. A method of making a beverage, comprising:
providing a cartridge having a sealed compartment that contains a gas source material including a solid molecular sieve having an adsorbed gas, and an aroma component;
introducing a fluid into the sealed compartment to cause the gas source material to release the adsorbed gas and to cause the aroma component to combine with the released gas;
delivering the combined gas and aroma component to a precursor liquid to dissolve the combined gas and aroma component in the precursor liquid; and
dispensing the precursor liquid with dissolved gas and the aroma component as a beverage.

16. The method of claim 15, wherein introducing the fluid includes injecting water into the sealed compartment via an inlet of the cartridge.

17. The method of claim 16, wherein introducing the fluid includes piercing the cartridge to define the inlet.

18. The method of claim 15, wherein introducing the fluid releases the aroma component from an encapsulant.

19. The method of claim 15, wherein the gas source material includes beads of a charged zeolite and the aroma component includes particles of encapsulated aroma material mixed with the beads of charged zeolite.

20. The method of claim 15, wherein delivering includes delivering the combined gas and aroma component under pressure to a pressurized tank containing the precursor liquid.
